(19) United States
(12) Patent Application Publication
(10) Pub. No.: US 2018/0302526 A1
(43) Pub. Date: Oct. 18, 2018

(54) IMAGE READING APPARATUS, AND CONTROL METHOD FOR IMAGE READING APPARATUS

(71) Applicant: CANON KABUSHIKI KAISHA, Tokyo (JP)

(72) Inventor: Toshio Takahashi, Toda-shi (JP)

(21) Appl. No.: 15/949,923

(22) Filed: Apr. 10, 2018

(30) Foreign Application Priority Data
Apr. 17, 2017 (JP) 2017-081055

(51) Int. Cl. H04N 1/00; H04N 1/10; H04N 1/12; H04N 1/60

(52) U.S. Cl. CPC H04N 1/00997; H04N 1/1061; H04N 1/00814; H04N 1/6088; H04N 1/1235; H04N 1/6086; H04N 1/00819

(57) ABSTRACT

An image reading apparatus, including: a conveyance unit configured to convey a document along a conveyance path; a transparent plate provided to the conveyance path; a reading unit configured to read an image of the document passing the transparent plate; a detector configured to detect a foreign substance on the transparent plate from image data output from the reading unit; a light source provided to one end side face of the transparent plate; and a controller configured to control lighting-up of the light source based on a detection result of the detector.

### BACKGROUND OF THE INVENTION

### Field of the Invention

The present invention relates to an image reading apparatus which is configured to read an image of a document, and a control method for the image reading apparatus.

### Description of the Related Art

In recent years, many of image forming apparatus such as an image scanner, a digital copying machine, and a facsimile, which are configured to optically read an image of a document, are capable of performing a “flow-reading method” with use of an automatic document feeder (hereinafter referred to as “ADF”) to efficiently read documents. The “flow-reading method” is a reading method of conveying documents one after another from a document bundle placed on a document placement table of the ADF and reading the documents being conveyed with use of a fixed optical reading unit.

In some cases, dust (paper powder) adheres to front and back sides of the document placed on the document placement table, or a matter such as glue or whiteout adheres to the document. There is a case in which, when the document is conveyed, such adhering substance is rubbed against a transparent plate (flow-reading glass) arranged at a flow-reading position, with the result that the adhering substance stays on a surface of the transparent plate. Further, there is also a case in which dust is attracted from an outside due to influence of, for example, static electricity irrespective of the document, with the result that the dust adheres to the surface of the transparent plate.

In some cases, an image of the dust or adhering substance which stagnates on the surface of the transparent plate under such a circumstance is read by the optical reading unit, and appears as an image streak 214 in the read image as illustrated in FIG. 10.

FIG. 10 is an explanatory view for illustrating the image streak 214 which appears in the read image.

The image streak 214 is an image defect which occurs when a document is read by flow-reading. In a related art, there has been proposed a technology of detecting the image streak 214 by an image processing portion when the image streak 214 appears in the read image, and prompting a user to clean the transparent plate.

In Japanese Patent Application Laid-Open No. 2005-6109, there is disclosed a method of providing a reflective member immediately above the flow-reading position and detecting dust on a surface of the transparent plate during a period in which a document is not conveyed. That is, as illustrated in FIG. 11, a document 102 is conveyed above a transparent plate 105 in a conveyance direction CD. During a period in which the document 102 is not conveyed, an illumination device 106 for image reading provided to an optical reading unit 110 is used to illuminate the transparent plate 105 from an oblique lower side, to thereby detect dust on the surface of the transparent plate 105.

However, there is a case in which the image streak 214 cannot be removed even by detecting the appearance of the image streak 214 and performing display for prompting a user to clean the surface of the transparent plate 105. For example, the dust or adhering substance which adheres to the surface of the transparent plate 105 is very small. Thus, there is a case in which a user cannot find at which part of the transparent plate 105 the dust or adhering substance is present, with the result that the surface of the transparent plate 105 cannot be sufficiently cleaned.

Further, there is a case in which a user who is unfamiliar with handling of an image reading apparatus cannot find where in the image reading apparatus the transparent plate is provided. In some cases, such user cleans, rather than the transparent plate, a document table glass for placing a document to be read under a platen. There is also a case in which, because of the above-mentioned circumstances, a user cannot remove the image streak and makes a service call.

Further, it is conceivable that, as illustrated in FIG. 12, a user uses the illumination device 106 for reading an image of a document in order to visually recognize dust on the transparent plate 105. However, in this case, light rays emitted from the illumination device 106 enters a field of sight of a user, and the user may be dazzled by the light rays, with the result that there is difficulty in finding dust on the surface of the transparent plate 105.

### SUMMARY OF THE INVENTION

The present invention has been made to solve the above-mentioned problems. According to the present invention, a user is informed of a position of an adhering substance adhering to a transparent plate for document flow-reading so that the user can visually recognize the position with ease, thereby enabling a user to easily clean the transparent plate.

According to one embodiment of the present invention, there is provided an image reading apparatus, comprising:

a conveyance unit configured to convey a document along a conveyance path;

a transparent plate provided to the conveyance path;

a reading unit configured to read an image of the document passing the transparent plate;

a detector configured to detect a foreign substance on the transparent plate from image data output from the reading unit;

a light source provided to one end side face of the transparent plate; and

a controller configured to control lighting-up of the light source based on a detection result of the detector.

Further features of the present invention will become apparent from the following description of exemplary embodiments with reference to the attached drawings.

### BRIEF DESCRIPTION OF THE DRAWINGS

FIG. 1 is a sectional view for illustrating an example of a configuration of an image reading apparatus according to a first embodiment.

FIG. 2 is a perspective view for schematically illustrating the reader according to the first embodiment.

FIG. 3 is a block diagram for illustrating an example of a configuration of the reader according to the first embodiment.

FIG. 4 is a perspective view for illustrating a transparent plate provided to the reader according to the first embodiment.

FIG. 5 is a sectional view for illustrating the transparent plate provided to the reader according to the first embodiment.

FIG. 6 is a sectional view for illustrating a foreign substance adhering to a surface of the transparent plate provided to the reader according to the first embodiment.

FIG. 7 is a perspective view for illustrating an example of a configuration of the reader according to a second embodiment.

FIG. 8 is a block diagram for illustrating an example of a control configuration for the reader according to the second embodiment.

FIG. 9 is an explanatory view for illustrating the transparent plate in a third embodiment.

FIG. 10 is an explanatory view for illustrating an image streak which appears in a read image.

FIG. 11 is an explanatory view for illustrating a method of detecting dust in a related-art image reading apparatus.

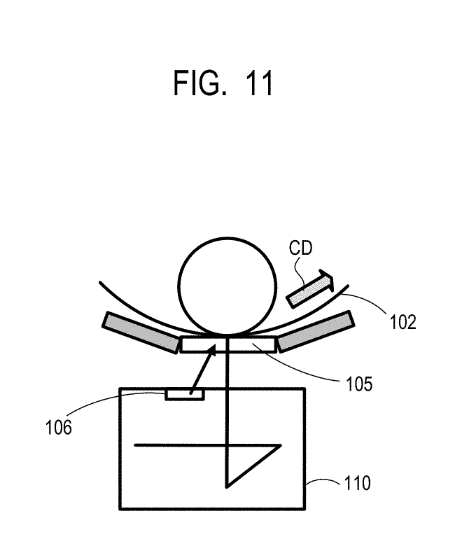

FIG. 12 is an explanatory view for illustrating a method of visually recognizing dust in the related-art image reading apparatus.

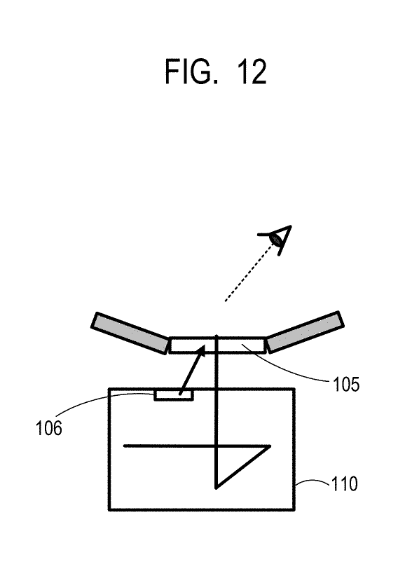

### DESCRIPTION OF THE EMBODIMENTS

A description will be provided of embodiments of the present invention with reference to the accompanying drawings.

### First Embodiment

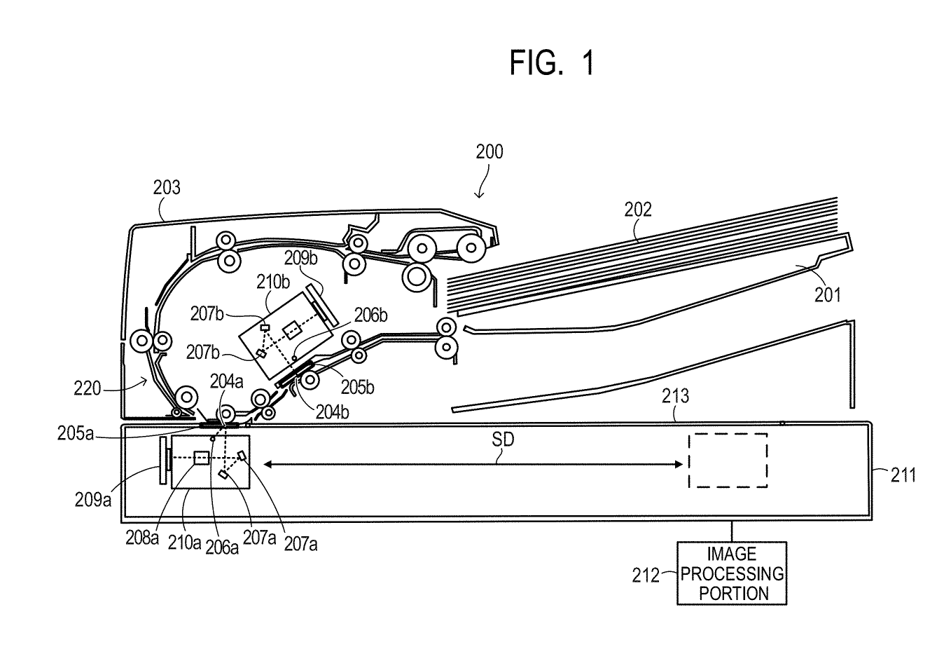

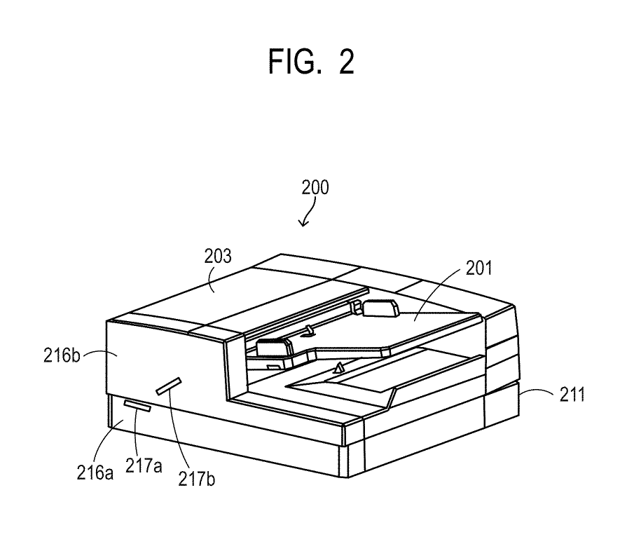

Now, with reference to FIG. 1 to FIG. 6, a description will be provided of an image reading apparatus 200 according to a first embodiment of the present invention. FIG. 1 is a sectional view for illustrating an example of a configuration of the image reading apparatus 200 according to the first embodiment. FIG. 2 is a perspective view for schematically illustrating the image reading apparatus 200 according to the first embodiment.

The image reading apparatus (hereinafter referred to as “reader”) 200 according to the first embodiment is applicable to, for example, a copying machine, an image scanner, and a multi-function printer (MFP). The reader 200 has a function of detecting a foreign substance, which may cause an image defect, on surfaces of transparent plates 205a and 205b at the time of reading a document by document flow-reading, and a function of notifying a user of a position of a foreign substance on the transparent plates 205a and 205b on which the foreign substance is detected to prompt the user to clean the transparent plates 205a and 205b.

The reader 200 includes an ADF 203 and a reader main body 211. The ADF 203 being a conveyance unit is an automatic document feeder which is configured to separate and feed documents 202 placed on a document tray 201 one after another and convey the documents 202 on a document conveyance path 220. The transparent plate 205a is provided at a flow-reading position 204a on the document conveyance path 220, and the transparent plate 205b is provided at a flow-reading position 204b on the document conveyance path 220. The ADF 203 is openable and closable with respect to the reader main body 211 by an opening and closing mechanism (not shown).

An optical reading unit 210a is provided to the reader main body 211. The optical reading unit 210a includes a document illumination device 206a, reflection mirrors 207a, an imaging optical system 208a, and a solid-state image pickup device 209a. The optical reading unit 210a reads an image of a front side of a document, which is conveyed by the ADF 203 and passes above the transparent plate 205a, through the transparent plate 205a (document flow-reading). The reader 200 is also capable of reading a document placed on the document table glass 213 while moving the optical reading unit 210a in a scanning direction SD.

Further, the optical reading unit 210b provided to the ADF 203 has the same configuration as the optical reading unit 210a, and is configured to read an image of a back side of a document, which is conveyed by the ADF 203 and passes above the transparent plate 205b, through the transparent plate 205b.

The image processing portion 212 performs image processing on image data read by the optical reading units 210a and 210b. In the following, when a description will be provided of a common feature of the optical reading units 210a and 210b and a common feature of the transparent plates 205a and 205b, those components are not distinguished, and are referred to as “optical reading unit 210” and “transparent plate 205” without subscripts “a” and “b”.

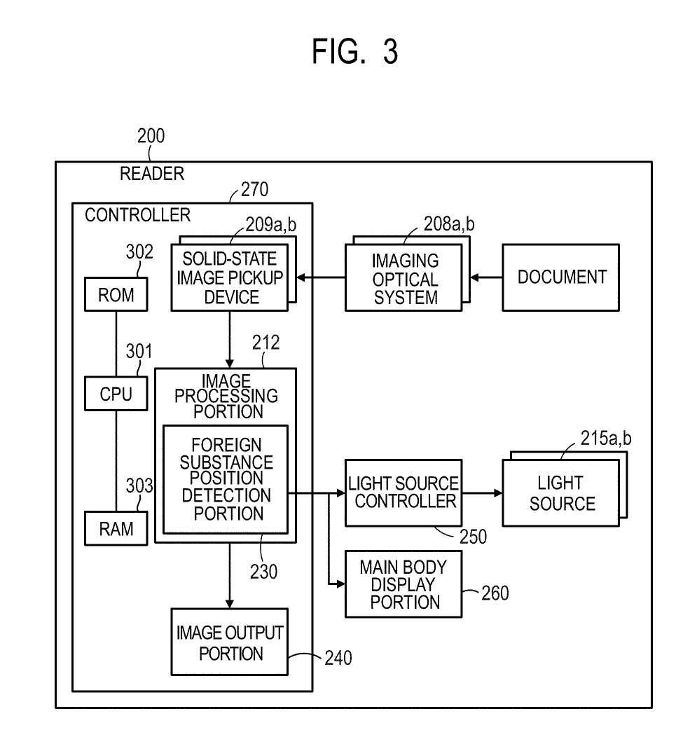

Further, as illustrated in FIG. 3, the reader 200 includes a controller 270. The controller 270 is configured to control the reader 200. The controller 270 includes a CPU 301, a ROM 302, and a RAM 303. The CPU 301 of the controller 270 loads a program stored in the ROM 302 to the RAM 303 and executes the program as needed to control the reader 200. Further, the controller 270 includes a solid-state image pickup device 209, an image processing portion 212, and an image output portion 240. Further, the reader 200 includes a light source controller 250. The light source controller 250 is configured to control a lighting-up state of each of light sources 215a and 215b.

Now, a description will be provided of a flow-reading method. The ADF 203 separates the documents 202, which are placed on the document tray 201, one after another by a conveyance roller arranged in the ADF 203, and conveys the documents 202 to the flow-reading positions 204a and 204b. At the flow-reading position 204a, there is arranged plate glass (flow-reading glass) being the transparent plate 205a arranged on the reader main body 211. Further, at the flow-reading position 204b, there is arranged plate glass being the transparent plate 205b arranged on the ADF 203. Optical reading units 210a and 210b are provided at positions facing the document across the transparent plates 205a and 205b, respectively, and are configured to read a document conveyed in the manner mentioned above.

Now, a description will be provided of the optical reading unit 210. A document illumination device 206 provided inside the optical reading unit 210 illuminates the document which is conveyed to the flow-reading position 204 in the manner as mentioned above. Reflected light (linear image light) from the front side of the illuminated document is guided to the imaging optical system 208 by the reflection mirrors 207 accommodated inside the optical reading unit 210, and is projected and imaged on the solid-state image pickup device 209 by the imaging optical system 208. The solid-state image pickup device 209 subjects the projected light (linear image) to photoelectric conversion, and transmits an output in a form of an electric signal to the image processing portion 212 engaged with the reader main body 211. In the document flow-reading, the document is read while being conveyed. Therefore, the above-mentioned linear image is formed into a two-dimensional image and processed by the image processing portion 212.

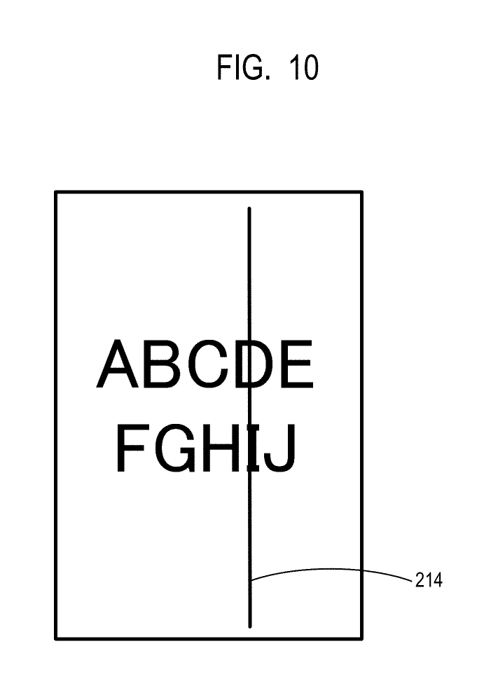

An image of, for example, dust or an adhering substance (dirt) (hereinafter referred to as “foreign substance”) stagnating on a surface of the transparent plate 205 is also guided to the solid-state image pickup device 209 by the imaging optical system 208 arranged in the optical reading unit 210. However, an image of the foreign substance is always formed at the same position on an image pickup device. Therefore, there is a case in which, as illustrated in FIG. 10, an image of the foreign substance appears as the image streak 214 in a read image.

As illustrated in FIG. 3, a module (foreign substance position detection portion 230) configured to detect a position of the foreign substance on the surface of the transparent plate 205 is incorporated in the image processing portion 212. The foreign substance position detection portion 230 being a foreign substance detector uses image data read by the optical reading unit 210a or image data read by the optical reading unit 210b to detect a position of a foreign substance, such as a position of dust on the surface of the transparent plate 205 or a position at which the adhering substance adheres. The foreign substance position detection portion 230 performs detection of a position of the foreign substance with use of image data read by the optical reading unit 210 at a timing, for example, before start of a reading job (that is, timing at which a document is not conveyed). Further, any method may be used as the method of detecting a position of a foreign substance, and a known method (for example, a method similar to the method disclosed in Japanese Patent Application Laid-Open No. 2005-6109) may be used. When a foreign substance is detected, the foreign substance position detection portion 230 notifies the light source controller 250 of the fact of detection. The timing at which the foreign substance position detection portion 230 detects a position of a foreign substance may be other timing. For example, detection of a position of a foreign substance may be performed after termination of the reading job.

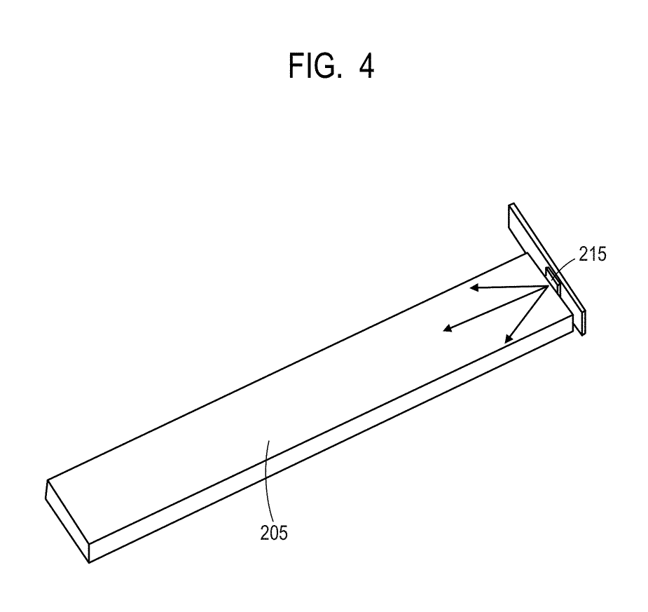

When the foreign substance is detected by the foreign substance position detection portion 230, the controller 270 controls the main body display portion 260 to display information as to the presence of the foreign substance to be informed to a user. It is not always required that the information as to the presence of the foreign substance to be informed to a user be displayed every time the foreign substance position detection portion 230 detects the foreign substance. For example, determination may be made on whether or not to display the information as to the presence of the foreign substance to be informed to a user based on the number and size of the foreign substance detected by the foreign substance position detection portion 230. Further, when the foreign substance is detected by the foreign substance position detection portion 230, the light source controller 250 transmits a lighting-up signal to the light source 215 (for example, white LED), which is arranged on one end side face of the transparent plate 205 as illustrated in FIG. 4, to control the light source 215 to light up. The light source 215a is arranged on one end side face of the transparent plate 205a, and the light source 215b is arranged on one end side face of the transparent plate 205b. When a foreign substance is detected from image data read by the optical reading unit 210a, the foreign substance position detection portion 230 notifies the light source controller 250 of the fact of detection, and the light source controller 250 controls the light source 215a, which is arranged on the one end side face of the transparent plate 205a, to light up. Further, when a foreign substance is detected from image data read by the optical reading unit 210b, the foreign substance position detection portion 230 notifies the light source controller 250 of the fact of detection, and the light source controller 250 controls the light source 215b, which is arranged on the one end side face of the transparent plate 205b, to light up. Determination may be made on whether or not to control the light source 215 to light up based on the number and size of the foreign substance detected by the foreign substance position detection portion 230.

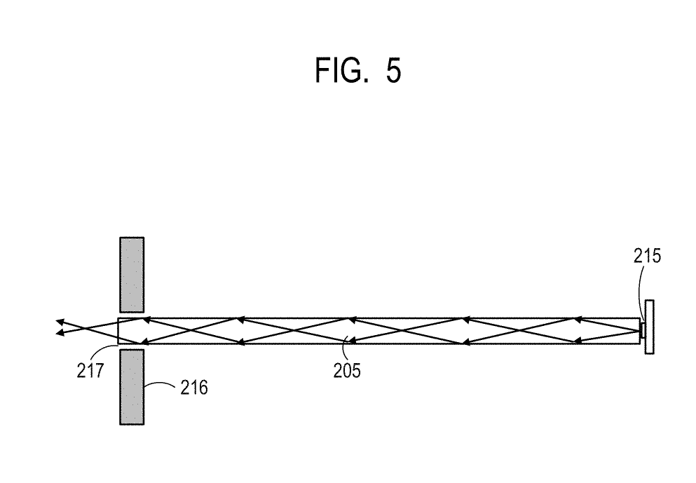

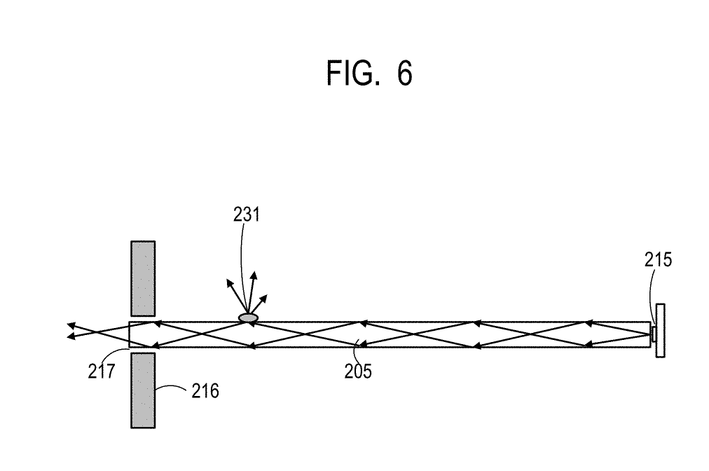

A light flux emitted from the light source 215 is propagated and guided while being totally reflected inside the transparent plate 205 being the plate glass as illustrated in FIG. 5, and part of the light flux exits from the other end side face on the opposite side. In general, in order to allow the light flux to be totally reflected and propagated inside the plate glass, it is required that an air layer be formed on the surface of the plate glass. Therefore, when a foreign substance 231 such as dust or an adhering substance adheres to the plate glass surface, the portion does not cause total reflection, with the result that, as illustrated in FIG. 6, part of the light may leak out from the transparent plate 205 being the plate glass. That is, it can be seen as if the light leaks out from a periphery of the foreign substance 231 or a portion directly below the foreign substance 231. Thus, it can be seen as if only the foreign substance 231 such as dust or an adhering substance (dirt) on the surface of the transparent plate 205 being the plate glass rises. Therefore, a user can easily specify a position of the foreign substance 231 such as dust or an adhering substance, thereby being capable of easily removing the foreign substance 231.

Further, the other end side face of the transparent plate 205a being the plate glass is exposed through an exposure window 217a (FIG. 2) provided to an exterior member 216a of the reader main body 211, and part of the light flux from the light source 215a is caused to exit toward the front surface side of the reader main body 211. Similarly, the other end side face of the transparent plate 205b is exposed through an exposure window 217b (FIG. 2) provided to an exterior member 216b of the ADF 203, and part of the light flux from the light source 215b is caused to exit toward the front surface side of the ADF 203. With this configuration, a position of the foreign substance 231 adhering to the transparent plate 205 can easily be informed to a user, thereby being capable of reliably promoting a user to clean the transparent plate having the foreign substance 231 adhering thereto.

The light source controller 250 controls the light source 215 in a state of lighting up to light off at a predetermined timing. For example, an “acknowledge button” is displayed together with the “information as to the presence of the foreign substance to be informed to a user” displayed on the main body display portion 260 as mentioned above. When the “acknowledge button” is pressed, the controller 270 notifies the light source controller 250 of that fact to control the light source 215 to light off. Further, there may also be employed a configuration in which, when a predetermined button of a main body operation portion (not shown) (including the main body display portion 260) is long-pressed, the controller 270 notifies the light source controller 250 of that fact to control the light source 215 to light off. Further, the light source controller 250 may control the light source 215 to light off at a timing after elapse of a predetermined time period after the lighting-up.

According to the first embodiment, the light source is arranged on at least one end side face of the transparent plate arranged at the flow-reading position, and the light flux of the light source is propagated and guided inside the transparent plate. With this configuration, it can be seen as if the dust or adhering substance adhering to the surface of the transparent plate rises, thereby enabling a user to visually recognize a position of the dust or adhering substance with ease. Further, the other end side face (the other end side face opposed to the one end side face on which the light source is provided) of the transparent plate is exposed through the exposure window provided to the exterior member of the reader main body or the ADF reader. With this configuration, a position on the transparent plate to be cleaned can be easily presented to a user from an outer side of the reader, thereby being capable of reliably prompting a user to clean the transparent plate having the foreign substance adhering thereto.

### Second Embodiment

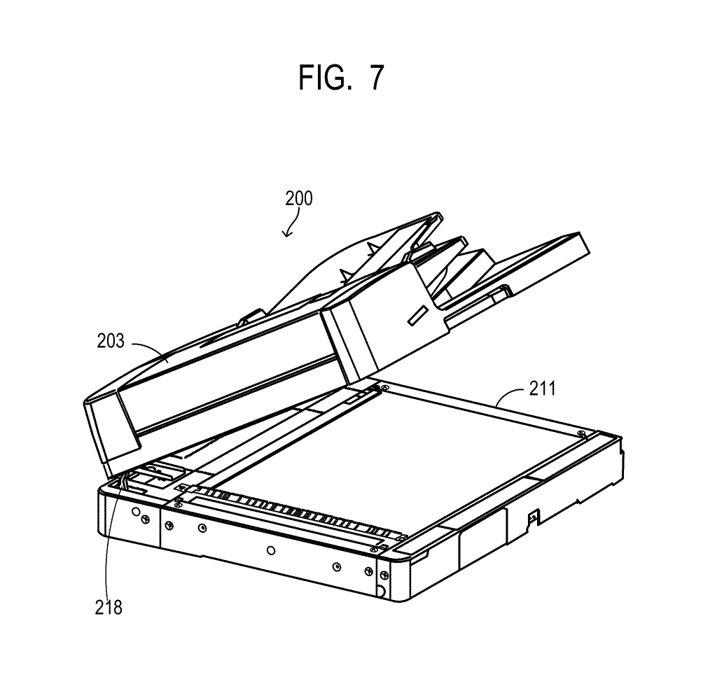

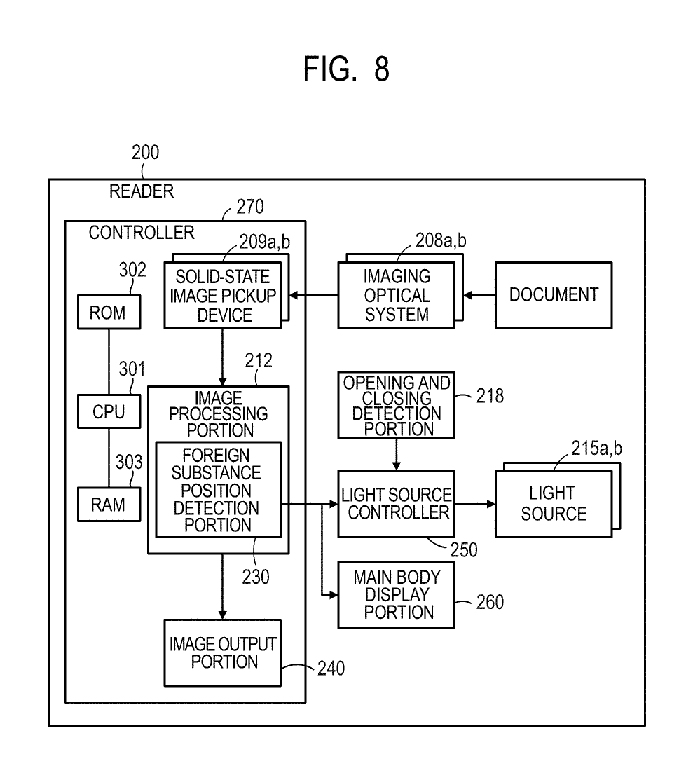

FIG. 7 is a perspective view for illustrating an example of a configuration of the reader 200 according to a second embodiment of the present invention. FIG. 8 is a block diagram for illustrating an example of a control configuration for the reader 200 according to the second embodiment.

As illustrated in FIG. 7, the reader main body 211 in the second embodiment includes an opening and closing detection portion 218 being an opening and closing detector configured to detect an opened state and a closed state of the ADF 203. As illustrated in FIG. 8, the opening and closing detection portion 218 transmits, to the light source controller 250, a signal based on an opening and closing angle of the ADF 203.

When a foreign substance is detected by the image processing portion 212, the light source controller 250 transmits a lighting-up signal to the light source 215 associated with the detected foreign substance. Further, when a closed state of the ADF 203 is detected by the opening and closing detection portion 218, the light source controller 250 controls the light source 215 associated with the detected foreign substance to blinkingly light up. For example, when a foreign substance is detected from image data of a front side of a document, the light source controller 250 controls the light source 215a to light up. Further, when the closed state of the ADF 203 is detected, the light source controller 250 controls the light source 215a to blinkingly light up. When a foreign substance is detected from image data of a back side of a document, the light source controller 250 controls the light source 215b to light up. Further, when the closed state of the ADF 203 is detected, the light source controller 250 controls the light source 215b to blinkingly light up.

A blinking light flux of the light source 215 is totally reflected and propagated inside the plate glass being the transparent plate 205, and blinking light exits through the exposure window 217 toward the front surface side of the reader main body 211. Therefore, a user can easily notice adhesion of the foreign substance. The exposure window 217 includes the exposure window 217a provided to the reader main body 211 and the exposure window 217b provided to the exterior member 216 of the ADF 203. That is, when the blinking light exits through the exposure window 217a, the fact that the foreign substance adheres to the surface of the transparent plate 205a provided to the reader main body 211 is notified to a user, thereby being capable of prompting the user to clean the surface of the transparent plate 205a. When the blinking light exits through the exposure window 217b, the fact that the foreign substance adheres to the surface of the transparent plate 205b provided to the ADF 203 is notified to a user, thereby being capable of prompting the user to clean the surface of the transparent plate 205b. As described above, it can be easily notified to a user which part is required to be cleaned for removal of the foreign substance.

In order to allow a user to clean the surface of the transparent plate 205, it is required that the ADF 203 be brought into the opened state. Thus, when the opening and closing detection portion 218 detects that the ADF 203 is in the opened state, the light source controller 250 controls the light source 215 in a state of blinkingly lighting up to be switched to a state of continuously lighting up. With this control, the foreign substance adhering to the transparent plate 205 can be seen as if it rises by the light of the light source 215, thereby enabling a user to visually recognize the foreign substance with ease. As a result, a user can reliably clean the surface of the transparent plate 205 having the foreign substance adhering thereto. When the opening and closing detection portion 218 detects again that the ADF 203 is in the closed state, the light source controller 250 controls the light source 215 in the state of continuously lighting up to be switched to the state of blinkingly lighting up, and repeats the above-mentioned control.

As described above, according to the second embodiment, for the purpose of improving ease of visual recognition, through the operation in association with the opening and closing detection portion of the ADF, when the foreign substance is detected in the closed state of the ADF, the light source is controlled to blinkingly light up, thereby being capable of enabling a user to notice the presence of the foreign substance. Further, when the user brings the ADF reader into the opened state to clean the transparent plate, the light source is controlled to continuously light up, thereby being capable allowing a user to visually recognize a position of the foreign substance adhering to the transparent plate with ease.

### Third Embodiment

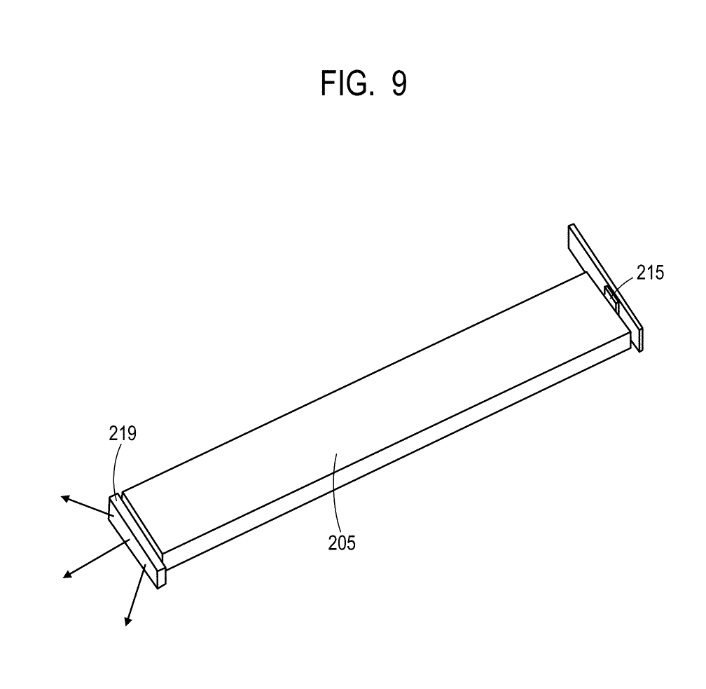

FIG. 9 is an explanatory view for illustrating a configuration of the transparent plate 205 in a third embodiment. As illustrated in FIG. 9, a colored transparent cover member 219 is arranged at an exit surface of the transparent plate 205 in the third embodiment. That is, a transparent cover member 219a is arranged at an exit surface of the transparent plate 205a, and a transparent cover member 219b is arranged at an exit surface of the transparent plate 205b.

For example, yellow-based or orange-based color is generally employed as a light source color which is likely to be visually recognized by a user. However, there is a case in which a light flux which is totally reflected and propagated inside the plate glass being the transparent plate 205 has a color with a green component. In order to change the green color to yellow-based color, the transparent cover member 219 having red-based color is arranged, thereby being capable of adjusting color to yellow or orange which is likely to be visually recognized by a user.

As described above, according to the third embodiment, for the purpose of improving ease of visual recognition, in general, the light (for example, with a color having a green component) from the exposure portion is converted to yellow or orange light-emitting color. With this, the ease of visual recognition by a user is improved, thereby being capable of more easily allowing a user to notice that dust or an adhering substance adheres to the surface of the transparent plate.

As described above, according to the embodiments of the present invention, when a foreign substance on the flow-reading transparent plate is detected, the light source arranged on one end side face of the flow-reading transparent plate is controlled to light up, thereby allowing the light flux emitted from the light source to be propagated inside the transparent plate. With this configuration, when the foreign substance such as dust or an adhering substance adheres to the surface of the flow-reading transparent plate, part of the light flux propagated inside the flow-reading transparent plate leaks to an outside from a periphery of the foreign substance to illuminate the foreign substance, and hence a position of the adhering foreign substance can be found more easily. Further, through exposure of the other end side face of the transparent plate from the exterior member, it can be easily found where the flow-reading plate is in the flow-reading transparent plate, and hence a position of a portion to be cleaned can be accurately informed to a user. Thus, the image streak caused by the foreign substance adhering to the flow-reading glass can be prevented.

According to the first, second, and third embodiments, a position of the foreign substance adhering to the flow-reading transparent plate can be informed so that a user can visually recognize the position with ease. With this, cleaning of the transparent plate by the user can be performed easily.

The configuration and contents of the various data mentioned above are not limited to those described above, and may vary depending on use and purpose.

In the foregoing, the embodiments are described. However, the present invention can be embodied in a mode of, for example, a system, an apparatus, a method, a program, or a recording medium. Specifically, the present invention may be applied to a system including a plurality of devices, or may be applied to an apparatus including one device.

Configurations based on various combinations of the above-mentioned embodiments are also encompassed within the scope of the present invention.

### OTHER EMBODIMENTS

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-081055, filed Apr. 17, 2017, which is hereby incorporated by reference herein in its entirety.

What is claimed is:

1. An image reading apparatus, comprising:
a conveyance unit configured to convey a document along a conveyance path;
a transparent plate provided to the conveyance path;
a reading unit configured to read an image of the document passing the transparent plate;
a detector configured to detect a foreign substance on the transparent plate from image data output from the reading unit;
a light source provided to one end side face of the transparent plate; and
a controller configured to control lighting-up of the light source based on a detection result of the detector.

2. An image reading apparatus according to claim 1, further comprising a display portion configured to notify a user of presence of a foreign substance based on the detection result,
wherein, when the display portion notifies a user of the presence of the foreign substance, the controller controls the light source to light up.

3. An image reading apparatus according to claim 1, wherein the controller controls lighting-up of the light source based on the number of foreign substances detected by the detector.

4. An image reading apparatus according to claim 1, wherein the transparent plate is provided so that the other end side face opposed to the one end side face on which the light source is provided is exposed through an exposure window provided in an exterior member of the image reading apparatus, and
wherein light from the light source is propagated inside the transparent plate and output from the other end side face.

5. An image reading apparatus according to claim 4, wherein the conveyance unit is provided so as to be openable and closable with respect to a main body of the image reading apparatus,
wherein the image reading apparatus further comprises an opening and closing detector configured to detect an opened state and a closed state of the conveyance unit,
wherein, when a foreign substance is detected by the detector and the opened state of the conveyance unit is detected by the opening and closing detector, the controller controls the light source to blinkingly light up, and when the foreign substance is detected by the detector and the closed state of the conveyance unit is detected by the opening and closing detector, the controller controls the light source to continuously light up.

6. An image reading apparatus according to claim 4, further comprising a cover member, which is provided to the exposure window, and is configured to adjust color of light output from the other end side face.

7. An image reading apparatus according to claim 1, wherein the transparent plate includes a first transparent plate and a second transparent plate,
wherein the reading unit includes a first reading unit configured to read an image on a front side of the document passing the first transparent plate and a second reading unit configured to read an image on a back side of the document passing the second transparent plate,
wherein the light source includes a first light source provided to one end side face of the first transparent plate and a second light source provided to one end side face of the second transparent plate, and
wherein the controller controls the first light source and the second light source to light up the first light source based on a detection result of a foreign substance from image data output from the first reading unit by the detector and to light up the second light source based on a detection result of a foreign substance from image data output from the second reading unit by the detector.

8. A control method for an image reading apparatus, the image reading apparatus comprising: a conveyance unit configured to convey a document along a conveyance path; a transparent plate provided to the conveyance path; a reading unit configured to read an image of the document passing the transparent plate; and a light source provided to one end side face of the transparent plate, the control method, comprising:
detecting a foreign substance on the transparent plate from image data output from the reading unit; and
controlling the light source to light up based on a detection result by the detecting.
